(19) United States
(12) Patent Application Publication
(10) Pub. No.: US 2020/0171993 A1
(43) Pub. Date: Jun. 4, 2020

(54) Aesthetic Floor Covering System

(71) Applicant: Autoneum Management AG, Winterthur (CH)

(72) Inventors: Flavien LOISIER, Heckmondwike (GB); James TAYLOR, Volketswil (CH)

(21) Appl. No.: 16/615,073

(22) PCT Filed: May 28, 2018
(86) PCT No.: PCT/EP2018/063875

§ 371 Date: Nov. 19, 2019

(30) Foreign Application Priority Data
Jun. 1, 2017 (EP) 17174111.9

(51) Int. Cl. B60N 3/04; B60R 13/08

(52) U.S. Cl. CPC B60N 3/042; B32B 27/065; B60R 13/0815

(57) ABSTRACT

Moulded floor covering system for acoustic attenuation of an automotive vehicle comprising a surface layer, a thermoplastic elastomeric base layer with a density of at least 0.5 kg/m3, and a decoupling layer, characterised in that the facing layer comprises an adhesive layer jointed to the surface of the base layer and an adherent pile of fibrous flock standing substantially on end in the adhesive forming the surface coverage.

### TECHNICAL FIELD

The invention is directed to an aesthetic floor covering system for vehicles and a method for producing such an aesthetic floor covering system.

### BACKGROUND ART

Today automotive flooring covering systems are made with a tufted or nonwoven surface facing the passenger area. Such flooring systems are usually moulded to comply with the shape of the cars body in white for instance including or levelling out any humps or ribs for power train or chassis. These floor coverings require high wear resistance in the areas where the passenger or other cargo touch or scuff the surface, in addition the flooring system must be able to resist puncture. These mechanical properties are obtained by the intrinsic stiffness of the needle punched nonwoven carpet layer or by the decoupling layer or layers used to make the tufted carpet surface, in particularly the layers holding the tufts and the adjacent coupled decoupling layer. Underneath the initial tufted or nonwoven surface layer a mass layer may be used to increase the weight of the flooring system. This might be combined with a spring type or decoupling layer in the form of foam or felt layer.

State of the art mass layer—also known as heavy layer—material is made as a semi-finished product based on thermoplastic compound as a binder, preferably ethylene-propylene-diene rubber (EPDM) and/or ethylene vinyl acetate (EVA) and/or thermoplastic elastomers based on olefin (TPO), and a filler for instance barium sulphate and/or chalk. The thermoplastic material is mixed and calendared in the required thickness and sold as a semi-finished product. The semi-finished product is moulded to the required shape eventually laminated or combined with the other layers to form the flooring system. The semi-finished product may be formed and back foamed before the carpet surface—tufted or nonwoven—is laminated on top.

In 1960ties and 1970ties an alternative flooring system was used combining rubber floor mats with flock coated areas for instance GB 1091523 discloses a combined floor system with a base sheet formed of a thermoplastic material, bonded fiber fabric or vulcanized rubber material. This base sheet is flock coated with fibers using curable latex adhesives based on natural or synthetic rubber. Already the patent discloses the biggest problem of these adhesives, as the disclosure states that the adhesive bonding the flocks might be scraped off the base sheet by abrasion. The parallel application GB 1091524 gives as solution for this problem the usage of depressions in the base sheet surface in which the fibers are bonded in tufts preventing the scraping off from happening. However this would complicate the surface structure and not all customers like to have indented floor surfaces.

Although in general flocked products were introduced in the car in the 60ties and 70ties, they disappeared again as covering for the major floor area due to low wear and poor surface coverage of the fibers.

There is a trend in changing usage of cars, more people will likely jointly own or share a car. In addition new car systems, like battery electric vehicles or autonomous driven vehicles are introduced in the market.

These cars will have an increased need for high wear and cleanable flooring in particularly for the main floor area between and underneath the seats. However these carpet systems also function and will continue to function as noise attenuating trim parts, whereby a mass layer together with a decoupling layer form a spring mass system.

In the state of the art nonwoven carpets the nonwoven top layer is mainly responsible for the mechanical structure and performance, like tear resistance and puncture resistance, while in tufted carpets this function is taken by the primary and secondary decoupling layers of the tufted carpet. By reducing these forms of surface layer, the mechanical structural properties are no longer given.

It is the object of the invention to introduce an alternative to the currently sold nonwoven or tufted carpet systems, with a high wear and cleanable surface, however maintaining the noise attenuating properties.

### SUMMARY OF INVENTION

This object is achieved by a floor covering system with the features of claim 1, and by a method with the features of claim 12.

In particular, by a moulded floor covering system for acoustic attenuation of an automotive vehicle comprising a surface layer, a thermoplastic elastomeric base layer with a density of at least 0.5 kg/m³, and a decoupling layer, and with the facing layer comprising an adhesive layer jointed to the surface of the base layer and an adherent pile of fibrous flock standing substantially on end in the adhesive forming the surface coverage.

Surprisingly by combining an acoustic insulating system with a flocked surface it is possible to obtain a floor covering that is resistant to high wear and puncture and at the same time can perform as an acoustic floor covering for the main floor and dash area of a vehicle.

Preferably by adding an additional reinforcing layer adjacent and bonded to the elastomeric base and whereby the reinforcing layer is at least one of a nonwoven scrim layer, a textile layer like a knit, woven fabric, or a fibrous layer, it is possible to further diminish the risk of puncture of the floor system. Surprisingly already a nonwoven scrim layer firmly attached to the elastomeric base reduces the risk to puncturing, to a level comparable with state of the art carpets with nonwoven or tufted surfaces.

Preferably the reinforcing layer is attached to the back of the elastomeric layer or integrally with or within the elastomeric layer. The reinforcing layer is preferably substantially parallel to the surface elastomeric base layer.

Preferably the base layer including the reinforcing layer has a Young's modulus of between 20 and 135 MPa, preferably under 100 MPa, more preferably between 30 and 60 MPa enhancing the tear performance of the floor system and puncture resistance.

Surprisingly by using water based adhesive for binding the flock fibers to the elastomeric base material it is not only possible to reduce any volatile organic compound(s) release from the floor into the passenger compartment, it also shows a very high abrasion resistance and hardly any scraping off of the fibers on the surface.

The abrasion performance may be further enhanced by a fibrous flock comprising cut solid staple fibers with a length of between 1.5 and 3.5 mm, preferably between 2-2.5 mm. Preferably, the fibers have a fineness of between 10 and 25 dtex, preferably between 11 and 17 dtex.

It was found that using this length of fibers and preferably the range of fineness given, it is not only possible to increase the abrasion resistance of the surface layer, but also to obtain an improved soft touch haptic.

Surprisingly a combination of 1.5-2.5 mm and a fineness of 11 or 17 for instance would give a moulded carpet system with a very good abrasion or wear and at the same time an optimised touch haptic, comparing with normal standard car tufted carpet, more soft and lush than expected.

Preferably the thickness of the adhesive layer after drying is such that at least 6% of the length of the fibers, preferably at least 10%, can stand in the glue layer substantially perpendicular to the surface of the base layer, further enhancing the abrasion performance. Preferably on average not more than 15% of the length of the fibers will be within the glue when the fibers are directed perpendicular to the surface of the dried adhesive.

For example with a fiber length of 2 mm, it is possible to create a pile height above the glue of around 1.9-1.7 mm on average.

Preferably the moulded floor covering system according to the invention has an abrasion of at least 6500 cycles, preferably 8000 cycles, more preferably at least 10.000 cycles. Abrasion is measured using the Taber test, preferably according to ISO SAE J1530 using H18 wheels and 10N pressure.

Surprisingly by using the carpet floor system according to the invention a much better wear performance could be achieved in comparison to standard nonwoven or tufted carpets, making it a much durable solution for cars in particular for multi owner/user car systems.

As an adhesive for holding the cut fibers substantially perpendicular to the surface of the elastomeric base layer preferably water based adhesive, more preferably a water based adhesive based on polyurethane or acrylic, might be used. Preferably an adhesive system that cures and or solidifies during drying is used.

Preferably the adhesive layer has an area weight of between 150 and 300 g/m². Preferably the adhesive layer has a thickness of between 0.2 and 4 mm after final drying of the applied layer.

Preferably the adhesive is coloured to match the colour of the base and or cut fibers used. Preferably between 2 and 4% by weight of colour might be added without reducing the adhesive performance.

In the carpet system according to the invention a fibrous flock is used made of cut staple mono component fibers.

The fibers used are cut staple fibers, with a fiber length of between 1.5 and 3.5 mm, preferably between 2 and 2.5 mm. The fibers are preferably precision cut to obtain a small fiber length distribution.

During the production of the filaments also known as continuous filament tow into cut fibers, the surface of the fibers might be treated to enhance the static properties of the fibers during the flocking process.

The cutting of the fibers is the preferred solution to obtain short fibers as it may prevent any damage to the fiber, resulting in a better defined surface of the final product, in particular a better fiber length distribution, ergo closer to the wanted length, and a cleaner cut surface.

The fibers used can be of man-made fibers, preferably nylon, acrylic, mod-acrylic, polyester or rayon. The cut staple fibers are mono component cut filaments, preferably made of polyamide, preferably polyamide 6 or polyamide 6-6, or polyester, preferably poly ethylene terephthalate, or a polyolefin, preferably polypropylene or polyethylene.

To achieve very good abrasion Polyamide, preferably polyamide 6 or polyamide 6-6 are used.

The fibers might have a solid or hollow cross section. In addition the shape of the cross section might be variable, for instance round, trilobal, delta or multi-lobal to obtain differences in surface aesthetics for instance. Preferably a round cross section is used, and they can be mixed with or fully replaced by trilobal cross section fibers to increase the lustre of the surface obtained.

The fiber flock application process consists of coating the base layer with the adhesive at least in one section, applying the flock fibers on the base layer electrostatically. For this purpose, the flock fibers are introduced into a high voltage field as a result of which, as charge carriers, the fibers are introduced into a high voltage field as a result of which, as charge carriers, the fibers are transported to the adhesive-coated substrate at right angles. The adhesive coated base layer surface forms the earth pole and may be vibrated by electro pneumatic means. The fibers that penetrated the adhesive layer are retained there, forming a dense pile. Excess flock may be removed by suction and the product may be dried for instance using drying means like a hot air. Free fibers can be removed by brushing and or suction for instance.

The final fibrous surface layer formed has an area weight of between 100 and 380 g/m² based on the fiber content alone. In particularly on the section less prone to abrasion the lower area weight might be used and depending on the abrasion intensity the area weight, hence the density of the pile can be increased.

The moulded floor covering system according to the invention comprises a thermoplastic elastomeric base layer comprising at least an inorganic filler, like for instance barium sulphate or calcium carbonate. Preferably the total filler content is between 65 and 95% by weight.

The thermoplastic base layer is functioning as a barrier layer in an acoustic spring mass system and should be impervious as well as materially connected to the spring layer formed by the decoupling layer, at least for the main part of the surface.

Preferably the impervious barrier layer is made of a thermoplastic material selected from the group consisting of ethylene vinyl acetate (EVA) copolymer, polyester, polyethylene terephthalate, high density polyethylene, low density polyethylene, linear low density polyethylene, polypropylene, thermoplastic elastomer, thermoplastic rubber and polyvinyl chloride (PVC) or any combination of the foregoing.

The area weight of the elastomeric base material is preferably between 500 and 6000 g/m², preferably between 500 and 2500 g/m².

The thickness of the material is preferably between 0.5 and 6 mm and might vary throughout the part.

The moulded floor covering system according to the invention further comprises a decoupling layer adjacent the thermoplastic elastomeric base layer including the reinforcement layer. The decoupling layer can be one of an open cell foam layer, either slab foam or injected foam, open pour or a fibrous felt material.

The fibrous felt layer used as decoupling layer may comprise of a binder and fibers, or fibers alone.

The binder can be any type of thermoplastic material that can melt during moulding and bind the fibers together to form a consolidated fibrous layer.

Alternatively or additionally the felt layer can be consolidated by a mechanical process known in the art for instance needling.

The fibers used might be staple fibers or endless filaments. If the word fibers is used both staple fibers and endless filaments are meant except if the type of fibers is explicitly mentioned.

The fibers comprise at least one of natural fibers, like cotton, mineral fibers, like glass or basalt fibers, or man-made fibers selected from the consisting of, polyamide (nylon) such as polyamide 6 or polyamide 66, polyester such as polyethylene terephthalate (PET) or polyolefin such as polypropylene or polyethylene or mixtures thereof.

The fibers might come from a virgin, reclaimed or recycled source, for instance in the form of shoddy material, preferably shoddy cotton, synthetic shoddy, polyester shoddy or natural fiber shoddy.

Reclaimed fibers are preferably produced from textile fabrics. The shoddy type is defined by having at least 51% by weight of the material included, 49% can come from other sources. So for instance shoddy polyester contains at least 51% by weight of polyester based materials. Alternatively the shoddy material can be a mixture of different synthetic and natural fibers, whereby not one type is prevailing.

The fibers may also come from regenerated sources, like for instance regenerated polyester.

The fibers used for the decoupling layer may have a solid cross section but also fibers with a hollow cross section might be preferred or a combination of fibers with a hollow and solid cross section might be used. For instance to further enhance the durability and or to obtain a lighter part.

Surprisingly the use of a combination of fibers including frizzy fibers for instance hollow conjugate curled fibers further enhances the loftiness and softness of the decoupling layer and the acoustic performance of the overall moulded floor covering system.

In case of staple fibers used for the decoupling layer they have preferably a fiber length of between 28-76 mm, preferably between 32-64 mm.

The fibers—staple fibers or endless filaments, used for the decoupling layer are preferably between 1.7 and 28 dtex, preferably between 3 and 15 dtex, preferably between 3 and 12 dtex.

Eventually foam chips might be added to the decoupling layer based on fibrous felt. Preferably up to 30%, more preferably up to 25% of the total area weight of the layer might be foam chips or shredded foam. Preferably the foam is based on polyurethane foam, preferably soft polyurethane foam. The density of the foam used is preferably between 10 and 100 kg/m-3, preferably between 20 and 90 kg/m3. the size of the shredded foam pieces or chips is preferably between 2 and 20 mm, preferably between 3 and 15 mm.

Preferably the fibers in the layer are bonded with a thermoplastic binder.

The binder can be applied in the form of a powder, flakes or fiber.

As thermoplastic binder preferably at least one of the materials selected form the group consisting of polyester, preferably polyethylene terephthalate, polyolefin, preferably polypropylene or polyethylene, polylactic acid (PLY) and polyamide such as polyamide 6 or polyamide 66, or any of their copolymers may be used.

For example as binder a low melt polyester or polyolefin with a melt point lower than the filler fibers can be used. Preferably bi-component fibers might be used for instance a core sheath type of fiber with the sheath forming the binder component and the core forming the fiber felt material. For instance a coPET/PET bicomponent fiber whereby the coPET forms the binder and the PET forms the fibers within the felt material after moulding.

Preferably at least 0-50% by weight of the final felt material is formed by binder, preferably 10-40%, and even more preferred 20-30% by weight. The binder is preferably applied in the form of fibers.

Preferably the decoupling layer has an area weight of between 80-2500 g·m-2, preferably up to 1200 g·m-2 preferably up to 1000 g·m-2.

The fibrous layer after moulding might be having a constant area weight or a constant density. The thickness and area weight might also vary over the surface depending on the final shape and acoustic requirements.

The fibrous layer might be produced according to known processes for instance using the process of carding, cross lapping and needling or the alternative process of air laid and eventually needling to produce a consolidated fibrous mat the mat can be cut in blanks to be used in the moulding process. Alternatively the fibrous material can be directly laid into a mould and consolidated for instance using the device for moulding fibrous material as disclosed in EP 2640881

As a decoupling layer also a standard open cell foam material may be used as an alternative according to the invention. The decoupling layer may be formed from any type of thermoplastic or thermosetting foam. Preferably the decoupling layer is made of polyurethane foam.

Preferably the foam has a density between 25 to 100 Kg/m³, preferably 35 to 80 Kg/m³, preferably 45 to 70 Kg/m³.

The decoupling layer has preferably a low compression stiffness of less than 20 kPa, preferably above 4 kPa, preferably between 5 and 15 kPa, preferably between 5 and 10 kPa, measured according to the current ISO 3386-1. The measured stiffness is the compression stress value CV40, also called CLD40 value, measured at 40% compression. In general a softer foam is better from acoustic point of view but might have the drawback of having too low rigidity such as tread strength, for instance being too soft and spring back too much when pressing on the trim part for example when standing on the trim part while stepping in or out of the vehicle.

The foam can be produced in foam blocks and cut in to layers with the right thickness to be moulded to the final part. Alternatively, it may be applied according to the reaction injection moulding process whereby the foam is directly reacting in the mould forming the final shape. Preferably it is attached to the thermoplastic elastomeric layer during injection moulding of the foam, preferably on the surface including the reinforcement layer. All 3 layers forming a bonded shaped part.

The thickness and stiffness of the decoupling layer independent of the material chosen may be optimised to meet acoustic and stiffness targets as well as overall rigidity requirements of the trim part. In addition the thickness is dependent on space restrictions in the vehicle. Preferably the thickness can be varied over the area of the part to follow the available space in the vehicle. The thickness available may vary between 1 and 100 mm but in most cases the thickness varies between 5 and 40 mm. Typical overall average thickness of decoupling layers of a carpet or inner dash is normally between 15 and 25 mm, e.g. in average about 20 mm.

The method for producing the moulded floor covering system according to the invention comprises at least the following step in consecutive order where applicable:
1. Providing a moulded system comprising in consecutive order at least an elastomeric base layer, a reinforcement layer and a decoupling layer moulded in the final wanted shape. Whereby all layers are materially connected to the adjacent layers. Preferably the reinforcement layer is integrally connected to the elastomeric base layer and the decoupling layer. The decoupling layer might be one of slab foam, injection foam, open poured foam or a fibrous felt material, preferably from shoddy fiber material.
2. Adding the adhesive to the surface of the elastomeric base material facing away from the reinforcement layer and adjacent decoupling layer. Preferably a water based adhesive is used with at least 50% initial water content. The water based adhesive should not form a skin during the process and should be viscous enough to hold up the fibers during application in a substantial perpendicular direction to the surface of the base layer. Preferably the adhesive has a viscosity of at least 1000 mPas, preferably between 1100 and 6000 mPas, preferably between 4500 and 5500 mPas, for instance 5000 mPas. (The viscosity can be measured with a Brookfield RVT with a spindle 3, at 20 RP, 20° C.)
3. Applying the cut staple fibers to the adhesive using an electrostatic application system. By applying at least an electrostatic driving force on charged flock fibers, the fibers are applied in a direction perpendicular to the surface of the elastomeric base material. In the moulded system according the invention the surface of the elastomeric material is moulded into shape, the application system should be able to adapt to the contour of the surface to obtain an even surface effect with all fibers substantially perpendicularly to the surface of the elastomeric base layer. For instance using a robotic arm.
4. Drying the moulded system such that the adhesive is cured and or consolidated to form a stable elastic layer holding the fibers in position.

The fiber application can be done for the entire surface of the moulded part at once or in sections. For instance the areas prone to high wear or more visible can be flocked with a higher length fiber while areas which are less visible or less prone to wear can be flocked with shorter length fibers. Alternatively the density of the fibers in the different areas can be varied, with lower densities in the low wear areas. This would have the advantage of saving weight in the overall trim part.

Also sections with different fiber density can be obtained by for instance decreasing the flocking distance, increasing the field strength and or the flocking time or by adding or increasing the electro pneumatic driving force.

Preferably between the surface to be covered and or the fiber or adhesive applicator, a template is placed provided with an opening of desired shape and dimension, before applying adhesive and or the cut fibers. More than one template can be used to form intricate patterns using different fiber sizes, fiber finesse and or colour and or structures. For instance areas can be filled with trilobal fibers to obtain areas with high lustre.

The fibers can be applied with electrostatic alone or in combination with electro pneumatic means.

The step of applying fibers might be repeated several times to increase the density of the fibers or to apply different types of fibers. If different fibers are required than also the step of applying adhesive might be repeated eventually in section. After each step of applying the fibers and preferably after an initial drying the adhesive the loose fibers might be taken off for instance by vacuum suction means and or by pneumatic means.

The adhesive might be dried in steps, in an initial step the adhesive is dried enough to prevent the fibers from falling out or moving away from the upright initial position, after this phase the material can be handled for instance for additional fiber applications, cleaning of loose fibers or cutting of the final part structure. In a second phase the adhesive is dried to form the final strong bond necessary to obtain the high wear and puncture resistance.

Before applying the adhesive a pre-treatment of the surface of the elastomeric base layer might be done to eliminate any impurities and to increase the surface tension to increase bonding.

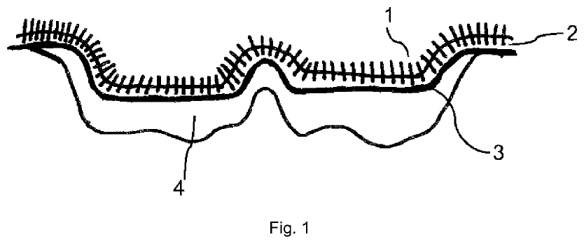

FIG. 1 is showing a typical moulded floor covering system for acoustic attenuation of an automotive vehicle according to the invention comprising a thermoplastic elastomeric base layer 3 and a decoupling layer 4. It further comprises a surface layer consisting of an adhesive layer 2 jointed to the surface of the base layer 3 and an adherent pile of flock fibers 1 standing substantially on end in the adhesive 2 forming the surface coverage. The flock fibers are positioned substantially perpendicular to the surface of the elastomeric base layer.

In the following examples of the surface performance are given.

### EXAMPLE 1

A thermoplastic elastomeric base material was formed of polyolefin elastomer (POE) with 80% filler content calendared into a thin flat layer of roughly 1000 g/m². The surface was flamed to eliminate any impurities or release agents. The wet adhesive was applied with an initial area weight of 333 g/m². Polyamide 6 fibers with a length of 2.5 mm and 11 dtex fineness were used as fiber flock. The fiber flock was applied perpendicular to the surface using a hand held electrostatic flocking machine. The sample was dried and measured for weight and abrasion performance.

The final flock with an area weight of 259 g/m² gave a good surface coverage and a nice haptic soft touch. The amount of adhesive after drying was found to be 171 g/m².

Surprisingly the abrasion already reach an average of 6168 cycles before a failure could be observed (failure means that the background in our case the elastomeric layer can be observed)

### EXAMPLE 2

A second example was made in the same manner as example 1, with same base layer material and adhesive. On an average of 3 samples the 210 g/m² initial wet adhesive was applied and 104 g/m² was measured after drying.

Polyamide 6 fibers with a length of 2.5 mm and 17 dtex fineness were used as fiber flock.

Also here the fibers gave a good coverage, nice and pleasant aesthetics and haptic. The fiber area weight measured was on average 288 g/m² and the final adhesive after drying was around 104 g/m². For this example an even higher wear performance was observed with an average of 11734 cycles before the surface failed.

Although this sample has less weight of fibers and adhesive compared to example 1, it performed better in the wear test.

### COMPARATIVE EXAMPLE

A state of the art needle punched nonwoven moulded carpet sample with a 400 g/m² fibrous surface only achieved 850 cycles in comparison.

A state of the art polyester tufted carpet surface achieved 4900 cycles before failure with a standard surface weight of between 300 to 700 g/m².

From these samples it can be seen that using the moulded floor covering according to the invention would enhance the optics and haptic as well as the wear in comparison to standard used floor systems.

1. Moulded floor covering system for acoustic attenuation of an automotive vehicle, comprising:
a surface layer;
a thermoplastic elastomeric base layer with a density of at least 0.5 kg/m3;
a decoupling layer; and
wherein the facing layer comprises an adhesive layer jointed to the surface of the base layer and an adherent pile of fibrous flock standing substantially on end in the adhesive forming the surface coverage.

2. The moulded floor covering system according to claim 1, further comprising a reinforcing layer adjacent and bonded to the elastomeric base layer, and whereby the reinforcing layer is at least one of a nonwoven scrim layer, a textile layer and a fibrous layer.

3. The moulded floor covering system according to claim 1, whereby the adhesive layer is water based adhesive or acrylic based adhesive.

4. The moulded floor covering system according to claim 1, whereby the adhesive layer has an area weight of between 150 and 300 g/m2.

5. The moulded floor covering system according to claim 1, whereby the thermoplastic elastomeric base layer is impervious and comprises at least inorganic filler and whereby the total filler content is between 65 and 95% by weight.

6. The moulded floor covering system according to claim 1, whereby the impervious elastomeric base layer is made of a thermoplastic material selected from the group consisting of ethylene vinyl acetate (EVA) copolymer, polyester, polyethylene terephthalate, high density polyethylene, low density polyethylene, linear low density polyethylene, polypropylene, thermoplastic elastomer, thermoplastic rubber and polyvinyl chloride (PVC), or any combination of the foregoing.

7. The moulded floor covering system according to claim 1, whereby the fibrous flock comprises solid staple fibers with a length of between 1.5 and 3.5 mm.

8. The moulded floor covering system according to claim 1, whereby the fibrous flock is made of polyamide or polyester.

9. The moulded floor covering system according to claim 1 whereby the fibrous flock has an area weight of between 100 and 500 g/m2, preferably not more than 400 g/m2.

10. The moulded floor covering system according to claim 1, whereby the abrasion is at least 6000 cycles as measured with the Taber test according to ISO SAE J1530.

11. The moulded floor covering according to claim 1, whereby at least 6% and not more than 15% of the fiber length is within the glue for the majority of the fibers.

12. The moulded floor covering according to claim 1, with the height of the fibers sticking out of the adhesive layer forming the pile is between 1.2 and 3 mm.

13. A method of using a moulded floor covering according to claim 1, as a sound insulating floor covering on the main floor of an vehicle with a diesel or petrol engine, battery electric vehicle, hybrid vehicles, fuel cell vehicles, or an autonomous driving vehicle.

14. A method of producing the moulded floor covering according to claim 1, comprising:
providing a moulded part with at least a thermoplastic face layer, an optionally reinforcing layer and a decoupling layer, whereby all layers are laminated together and formed into the final shape;
applying at least once the wet additive to the surface of the thermoplastic base layer facing away from the decoupling layer;
applying the flock fibers using electrostatic means such that the fibers are substantially perpendicular to the surface of the thermoplastic base layer and are anchored within the glue layer at least with 6% of the fiber length; and
drying the trim part such that the adhesive becomes solidified.
